(19) United States
(12) Patent Application Publication
(10) Pub. No.: US 2005/0188763 A1
(43) Pub. Date: Sep. 1, 2005

(54) Method and apparatus for measuring the draft of a vessel

(76) Inventor: John J. Krejci, Easton, PA (US)

Correspondence Address: RATNERPRESTIA, P O BOX 980, VALLEY FORGE, PA, 19482-0980, US

(21) Appl. No.: 10/788,065

(22) Filed: Feb. 26, 2004

(51) Int. Cl. G01B 13/14; B63J 5/00; G01B 13/00; G01B 7/24; G01B 7/00

(52) U.S. Cl. 73/301; 114/343; 73/865.9

(57) ABSTRACT

A device for measuring the draft of a vessel including a tube of a known length having a lower end adapted to be immersed in water a fixed distance from a main deck or other reference point on the vessel, and a pressure sensor directly mounted at the lower end of the tube to measure the pressure head of the water at the lower end of the tube. The pressure at the lower end of the tube is used to determine the distance between a fixed reference point (draft line) on the side of the vessel and the actual surface of the water. This depth is then used to calculate the depth of the hull beneath the surface of the water or the draft of the vessel.

### FIELD OF THE INVENTION

The present invention relates generally to draft measurement devices, and more particularly, to a draft measurement and method for more reliably determining the distance between the surface of the fluid, e.g. water within which a vessel is floating and a draft mark or the hull of the vessel. The portion of the hull of a vessel between the water-line and a main deck or gunwale is generally referred to as “free-board”. Determination of draft or free-board of a vessel is used to, inter-alia, determine safe loading of the vessel.

### BACKGROUND OF THE INVENTION

Successful navigation of a vessel through a body of water requires the vessel's navigator to know the draft of the vessel. The draft of the vessel is defined as a depth of water displaced by the vessel, measured as the vertical distance from a water-line on a hull of the vessel where the hull breaks a surface of the water to a lowest point (bottom of the keel) on a submerged portion of the hull. The draft of the vessel can vary depending on the cargo and weight of the vessel. If the vessel is traversing dangerously shallow water the vessel may become grounded. Grounding of a vessel can endanger the lives of the vessel's crew and potentially cause a loss of cargo. In the celebrated case of the Exxon Valdez, grounding of the vessel caused significant short term (and some believe long term) environmental problems. Prediction of a vessel's draft is based upon a draft marking placed on the hull the time the vessel is certified for service. Such marking can be placed by techniques, performed for compliance with regulatory agencies, such as the U.S. Coast Guard.

One known method of measuring the actual draft of a vessel either empty or containing a partial or full cargo load employs a measuring tape. The user extends the tape from the deck of the vessel into the water. The draft is determined by subtracting 1) the measured distance from the deck to the water-line from 2) the deck to the lowest point of the hull (i.e. the bottom of the keel).

Using the measuring tape, a user leans over a side of the hull to see where the tape breaks the surface of the water. This method is disadvantageous for several additional reasons. First, wave action at the surface of the water can make observation of the water-line difficult. Second, careful visual observation of the measurement indicia while leaning over the side of the hull is at least inconvenient, and can be dangerous when strong wave action causes the hull to rock to-and-fro. Third, strong underwater currents can cause movement and flexing of an immersed portion of the measuring tape, reducing the accuracy of any measurements taken.

Examples of prior art methods and devices to measure draft or freeboard of a floating vessel are found in U.S. Pat. Nos. 3,396,470; 4,534,217 and 6,347,461. All of these patents detail devices that require internally capturing water that the vessel is floating in, in order to determine freeboard or draft of the vessel.

Therefore, there is a need to accurately determine the draft of a vessel by a method and apparatus that avoids the problems noted above. Accurate determination the draft of a vessel must be possible in the presence of wave action at the surface of the water and underwater turbulence, while eliminating the dangers and difficulties associated with observing and measuring the vertical location of a water-line using a tape measure.

### SUMMARY OF THE INVENTION

A primary goal of the present invention is to provide a reliable method and apparatus for accurately measuring the draft of a vessel.

Another goal of the present invention is to provide a device for measuring the draft of a vessel, wherein an individual can carefully, safely and conveniently determine the draft on a semi-continuous basis while the device is still placed in the fluid in which the vessel is floating.

A further goal of the present invention is to provide a device for measuring the draft of a vessel, wherein the pressure created by the level of water is used to determine the draft when the device is immersed in the water in which the vessel is floating.

A still further goal of the present invention is to decrease the difficulty of taking draft measurements and increase the accuracy of draft measurements as compared to prior art devices by compensating for fluctuations in an observable level of water used to determine the draft, the fluctuations arising from wave action, fluid surges due to hydrostatic pressure and underwater currents.

Yet another goal of the present invention is to reduce alignment errors between a device for measuring the draft of a vessel and the actual draft of the vessel.

According to one aspect the present invention is a device for measuring the draft of a vessel floating in a body of water. The device includes a tube having an upper end, a lower end, and a known length between the upper and lower ends. The device includes an electronic pressure sensor to measure the pressure at the lower end of the tube. Thus an operator can stand safely away from the edge of the vessel and observe the pressure created by placing the tube into the fluid to the point that is consistent with a reference point on the vessel.

Another aspect of the present invention is electronic draft measurement device for measuring the draft of a vessel including a tube of a known length having a lower end being immersed in water, and a pressure sensor measuring the pressure head of the water at the lower end of the tube. The method includes immersing the lower end of the tube in a fluid and aligning the upper end of the tube with a calibration mark on the vessel indicative of a known draft. The pressure created by the level of fluid is measured. The draft of the vessel is determined by translating the pressure into a unit of measure.

### BRIEF DESCRIPTION OF THE DRAWINGS

FIG. 1 is a fragmentary partial cross-sectional view of a draft measurement device according to the present invention.

FIG. 2 is a schematic elevational view illustrating use of draft measurement device in accordance with the present invention.

### DETAILED DESCRIPTION OF THE INVENTION

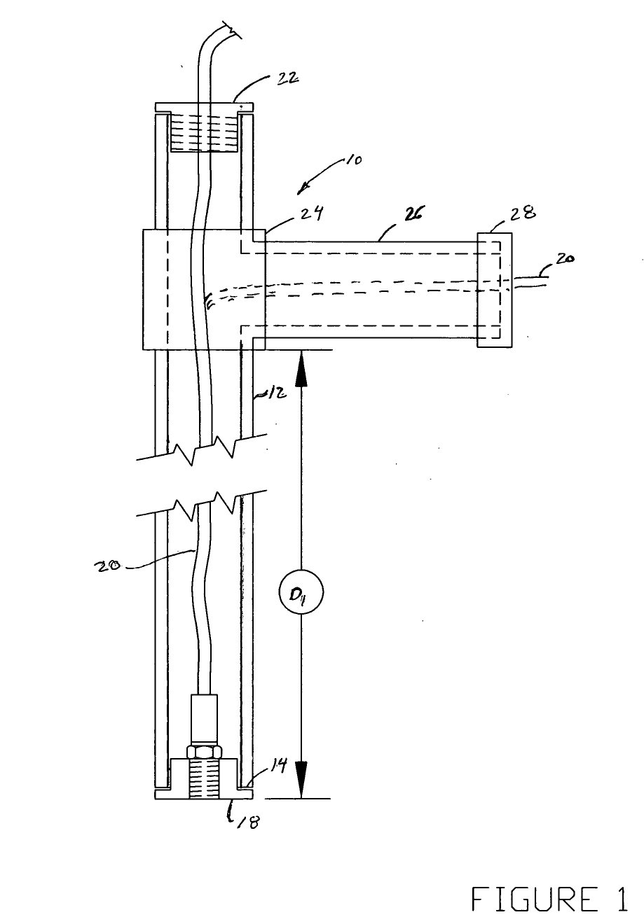

Referring to FIG. 1 the device 10 of the invention, in one form consists of a vertical tube 12 having a first end 14 and a second end 16. Disposed within first end 14 is a suitable pressure transducer 18 having an electrical conduit 20, which can be extended through a cap 22 on the second end of tube 12. In order to fix the length of the tube 12 extending from the deck of a vessel to a fixed location below the water line proximate, but not necessarily at the bottom of the keel of the vessel the tube 12 can include a collar 24, which determines a distance D1 between a horizontal positioning device, e.g. tube 26 and the pressure transducer 18. Tube 26 can be closed by a suitable cap 58.

The construction of the collar and tube device (24, 26) is critical only in the sense that it must enable the user to fix the distance (D₁) between the pressure transducer 18 and the deck of the hull of the vessel. Conveniently the tube 26 can be hollow and can be used to conduct the electrical conduit 20 through a side opening thus shortening the length of the electrical conduit 20, which is entirely within the requirements of the user.

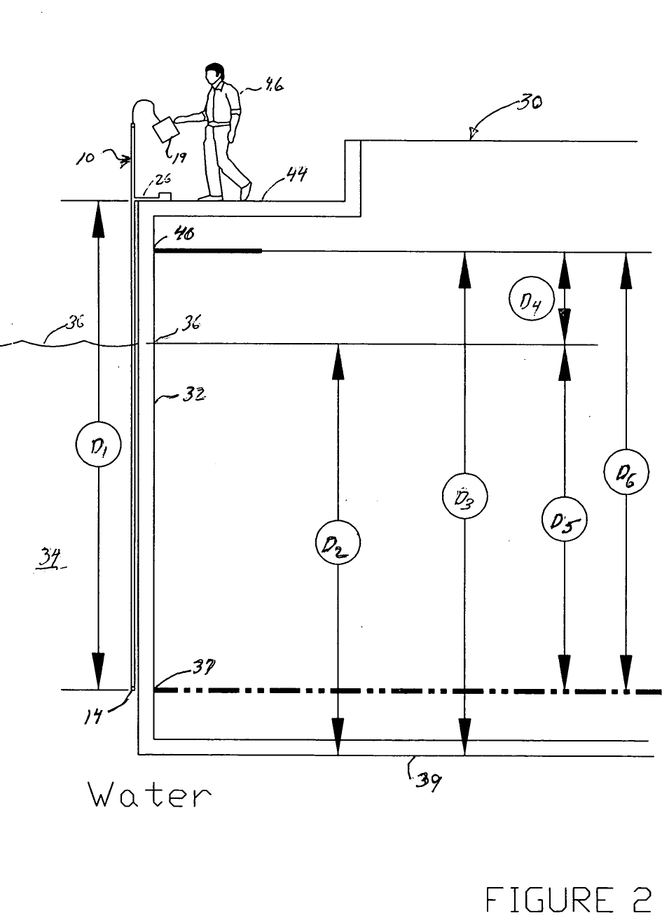

The electrical cord 20 is connected to a suitable pressure reading device (shown as 19 in FIG. 2), such a device being generally available in the market place. In one particular embodiment a pressure transducer measuring and readout device identified as PX-205 can be obtained from OMEGA Engineering of Stamford, Conn.

Referring to FIG. 2, use of a portable draft measurement device 10 constructed in accordance with the present invention, is depicted. For convenience, terms such as “above”, “below”, “right” and “left”, as used herein, are to be construed in the relative sense. The portable draft measurement device 10 is shown in a vertical operating position. A vessel 30, such as a ship, boat, barge or the like, includes a hull 32 having a portion of which sits below a surface 36 of a body of water 34. A mark or water-line 38 represents an average level of the water surface 36 against hull 32.

Referring again to FIG. 2, a user positions draft measurement device 10 supported by the fitting 26 on the top of the main deck 44 adjacent to hull 32 of vessel 30 with lower end 14 of tube 12 immersed in water 34 in which vessel 30 is floating, with the portion of tube 12 projecting above the water-line 36 transversely aligned with calibrated marker 40 on hull 32. Calibrated marker 40 indicates the known measurement D₃ of vessel 30. The draft measurement device 10 can either be held firmly by the operator 42 or it can be attached to the vessel to allow for remote monitoring of the draft. The user 42 properly orients device 10 in order to maintain substantially parallel alignment between tube 12 and vertical distance D₂ in the presence of wave action at water surface 36. It should be appreciated that, even with proper alignment, small deviations in the parallel alignment between tube 12 and draft line D₂ result from the wave action at surface 36 and underwater currents tending to cause relative motion between tube 12 and hull 32. Because the pressure sensor 18 can take multiple readings over a given period of time, this motion can be negated by averaging the pressure readings over a given time.

The draft of the vessel shown as the distance D₂ is the vertical distance between water-line 36 and a lowest point 39 of hull 32 immersed in water 34. A fixed or calibrated marker or draft mark 40 is placed on an exterior surface of hull 32 and represents a known vertical distance D₃ from the draft mark 40 to the bottom of hull 32. As will be described in detail below, a user 42 measures a vertical distance D₄ between the water-line 36 and calibrated marker 40 using the draft measurement device 10. Specifically, D₄ is determined by subtracting the distance D₅ measured from the lower end 14 of the submerged tube 12 to the water level 36, using the portable draft measurement device 10 from the known vertical length D₆ of tube 12 from the draft mark 40 to the lower end of tube 12 containing transducer 18. Thus D₄=D₆−D₅. From this measurement, draft D₂ can be determined. Specifically, draft D₂ of vessel 30 is determined by subtracting distance D₄ from the known vertical height D₃, i.e. D₂=D₃−D₄.

Cylindrically-shaped tube 12 of portable draft-measurement device 10, can be made from any rigid durable material, such as steel, aluminum and other structural materials such as polycarbonate resin. Alternatively tube 12 can be a semi-rigid material such as reinforced hose. The particular material will be determined by local water movement conditions. Tube 12 need not be removed from body of water 34. Tube 12 of portable draft measurement device 10 need not have a vertical length in excess of vertical height D₃ because distance D₄, measured by device 10, will always be less than vertical height D₃.

The pressure sensor 18 advantageously permits a user of the draft measurement device 10 to selectively measure the draft of the vessel when lower end 14 of tube 12 is immersed in water 34, whereby hydrostatic pressure within fluid 36 causes a change in pressure as measured by a pressure sensor 18 located just inside end of the tube 14. It is important to note that it is critical to locate the pressure sensor 18 as close to the lower end 14 of the tube 12 so that it measures the actual pressure created by the water indicating the true depth of the water at the end of tube 12, and not a depth that is reduced due to the compression of any air that might be trapped between the pressure sensor 18 and the lower end 14 of the tube 12. The actual pressure measured by sensor 18 is transmitted via cable or lead 20 to a suitable read-out device 19 which indicates the depth of the water and which can be a user 42 hand-held device.

With a draft measurement device 10 positioned as described above, the user can read the measurement D₅ on the digital display 19. From that value, the operator or a remote computer can calculate the actual draft of the vessel, and use that measurement to determine the amount of cargo loaded in or on the vessel.

It is also advantageous to be able to use two or more of the draft measurement devices on a single vessel whereby they can be connected to a single computer system by electrical cable or by a radio signal. The computer system can then automatically use these continuous draft measurements to determine the amount of cargo loaded on the vessel using a well known formula.

Other embodiments of the present invention will become readily apparent to those skilled in the art from the following detailed description, wherein the preferred embodiment of the invention is shown and described, simply by way of illustration of the best mode contemplated at the time the application was filed of carrying out the invention. As will be realized, the invention is capable of other and different embodiments, and its several details are capable of modifications in various obvious respects, all without departing from the invention.

Having thus described my invention what is desired to be secured by Letters Patent of the United States is set forth in the appended claims.

1. A draft measuring device for measuring the draft of a vessel floating a body of fluid comprising in combination:
a tube having an upper end, a lower end;
means to position said tube outbound and generally parallel to a vertical line through said vessel;
a pressure sensor in said lower end of said tube, said sensor positioned in said tube to prevent water entering said lower end of said tube; and
means to read pressure sensed by said pressure sensor and indicate a depth from a surface of said fluid to a fixed mark on said vessel above said surface of said fluid, whereby said depth can be used to determine said draft.

2. A device according to claim 1 wherein said tube is fabricated from a structural material.

3. A device according to claim 1 including means to fix said tube to a hull of a vessel.

4. An electronic draft measurement device for measuring the draft of a vessel floating in a fluid, comprising:
a tube of fixed length having a pressure sensor disposed in an end of said tube immersed in said fluid to a depth below the level of said fluid, said tube positioned generally parallel to a hull portion of said vessel pressure sensor to determining the distance between the lower end of the said tube and a fixed reference mark on said hull; whereby
said measured distance can be used to determine the distance of the vessel above the water-line which when subtracted from the known reference height of the vessel determines the effective draft of the vessel.

5. A device according to claim 4 including fabricating said tube from a structural material.

6. A device according to claim 4 including means to fix said tube to a hull of said vessel.

7. A method for determining the draft of a vessel floating in a fluid comprising the steps of:
measure the precise distance Dₘ from a draft mark on a hull of said vessel fixed at a point in said hull below a main deck of said vessel and above the level of said fluid to the bottom of the keel of said vessel;
determining the distance D_{w} from the surface of the fluid to the draft mark;
determining the draft of the vessel D from the formula D=Dₘ−D_{w}.
